(19) United States
(12) Patent Application Publication
(10) Pub. No.: US 2015/0098243 A1
(43) Pub. Date: Apr. 9, 2015

(54) ILLUMINATION DEVICE WITH SPACED-APART DIFFRACTIVE MEDIA

(71) Applicant: QUALCOMM Mems Technologies, Inc., San Diego, CA (US)

(72) Inventors: Kebin Li, Fremont, CA (US); Zhengwu Li, Milpitas, CA (US); Jian J. Ma, Carlsbad, CA (US); John H. Hong, San Clemente, CA (US)

(73) Assignee: QUALCOMM Mems Technologies, Inc., San Diego, CA (US)

(21) Appl. No.: 14/050,030

(22) Filed: Oct. 9, 2013

(51) Int. Cl. F21V 8/00

(52) U.S. Cl. CPC G02B 6/005; G02B 6/0033; G02B 6/0065
USPC 362/606; 362/611; 29/527.2

(57) ABSTRACT

This disclosure provides systems, methods and apparatus for an illumination system. In one aspect, the illumination system is a light guide that includes spaced-apart regions of medium containing diffractive features. For example, the medium may include holographic medium having holograms that are configured to redirect light, propagating through the light guide, out of the light guide. The spaces between the spaced-apart regions of media may be filled with a material having a lower refractive index than the light guide, thereby functioning as a reflective cladding in those spaces.

### TECHNICAL FIELD

This disclosure relates to generally to illumination devices. More particularly, this disclosure relates to illumination devices utilizing diffractive structures to direct light to and illuminate display devices such as, for example, electromechanical systems-based display devices. Various methods of use and fabrication of the illumination devices are described herein.

### DESCRIPTION OF THE RELATED TECHNOLOGY

Electromechanical systems (EMS) include devices having electrical and mechanical elements, actuators, transducers, sensors, optical components such as mirrors and optical films, and electronics. EMS devices or elements can be manufactured at a variety of scales including, but not limited to, microscales and nanoscales. For example, microelectromechanical systems (MEMS) devices can include structures having sizes ranging from about a micron to hundreds of microns or more. Nanoelectromechanical systems (NEMS) devices can include structures having sizes smaller than a micron including, for example, sizes smaller than several hundred nanometers. Electromechanical elements may be created using deposition, etching, lithography, and/or other micromachining processes that etch away parts of substrates and/or deposited material layers, or that add layers to form electrical and electromechanical devices.

One type of EMS device is called an interferometric modulator (IMOD). The term IMOD or interferometric light modulator refers to a device that selectively absorbs and/or reflects light using the principles of optical interference. In some implementations, an IMOD display element may include a pair of conductive plates, one or both of which may be transparent and/or reflective, wholly or in part, and capable of relative motion upon application of an appropriate electrical signal. For example, one plate may include a stationary layer deposited over, on or supported by a substrate and the other plate may include a reflective membrane separated from the stationary layer by an air gap. The position of one plate in relation to another can change the optical interference of light incident on the IMOD display element. IMOD-based display devices have a wide range of applications, and are anticipated to be used in improving existing products and creating new products, especially those with display capabilities.

Various systems and methods have been developed to illuminate display devices. One approach to provide lighting includes equipping implementations the display devices with a light guide that includes redirectors. Light from a light source is coupled into the light guide such that it propagates within the light guide by total internal reflection (TIR). Light propagating in the light guide is extracted by the redirectors and directed toward the display devices. To improve display quality and meet desired criteria, new devices are continually being developed to illuminate display devices.

### SUMMARY

The systems, methods and devices of this disclosure each have several innovative aspects, no single one of which is solely responsible for the desirable attributes disclosed herein.

One innovative aspect of the subject matter described in this disclosure can be implemented in an illumination system comprising a light guide having forward and rearward surfaces; a light source; a spaced-apart regions of medium disposed over the forward or rearward surface; and a material different from the medium disposed between adjacent spaced-apart regions. The light source is configured to inject light into the light guide such that the injected light propagates through at least a portion of the light guide by total internal reflection at one or both of the forward and rearward surfaces. Each spaced-apart region includes diffractive features that are configured to redirect at least some of the light propagating internally through the light guide out of the light guide.

In some implementations of the system, the diffractive features can include holograms. The holograms can be a reflection hologram and/or a transmission hologram. The holograms can include a volume hologram and/or a surface hologram. In various implementations of the system, the diffractive features can be configured to redirect light out of the light guide along a direction that is normal to the forward or rearward surface of the light guide. In various implementations, the diffractive features can be configured to redirect light out of the light guide at an angle less than about 10 degrees from a normal to the forward or rearward surface of the light guide. In various implementations, the diffractive features can include a first group of diffractive features that are configured to redirect light in a first wavelength range Δλ1 centered about a first wavelength λ1 and a second group of diffractive features that are configured to redirect light in a second wavelength range Δλ2 centered about a second wavelength λ2. In various implementations, the material disposed between adjacent spaced-apart regions can be devoid of diffractive features. In various implementations, the spaced-apart regions of medium can include a photopolymer. In various implementations, the material between adjacent spaced-apart regions can have a refractive index lower than a refractive index of the light guide.

Another innovative aspect of the subject matter described in this disclosure can be implemented in a display apparatus comprising a display and an illumination system comprising a light guide having forward and rearward surfaces; a light source; a spaced-apart regions of medium disposed over the forward or rearward surface; and a material different from the medium disposed between adjacent spaced-apart regions. The light source is configured to inject light into the light guide such that the injected light propagates through at least a portion of the light guide by total internal reflection at one or both of the forward and rearward surfaces. Each spaced-apart region includes diffractive features that are configured to redirect at least some of the light propagating internally through the light guide out of the light guide. Various implementations of the display apparatus can include a reflective display. The reflective display can be disposed facing the rearward surface of the light guide.

Another innovative aspect of the subject matter described in this disclosure can be implemented in an illumination system comprising a means for guiding light, the light guiding means having forward and rearward surfaces. The illumination system further comprises a means for emitting light, the light emitting means configured to inject light into the light guiding means such that the injected light propagates through at least a portion of the light guiding means by total internal reflection at one or both of the forward and rearward surfaces. The illumination system further comprises spaced-apart regions of medium disposed over the forward or rearward surface of the light guiding means. Each spaced-apart region includes means for diffracting light. The light diffracting means are configured to redirect at least some of the light propagating through the light guiding means out of the light guiding means. The illumination system further comprises a material different from the medium disposed between adjacent spaced-apart regions.

In some implementations of the illumination system, the light guiding means can include a light guide. In some implementations of the system, the light emitting means can include a light source. In some implementations, the light diffracting means can include holograms. The holograms can include a reflection hologram and/or a transmission hologram. In some implementations of the illumination system, the material different from the medium can have a refractive index less than a refractive index of the light guiding means.

Another innovative aspect of the subject matter described in this disclosure can be implemented in a method of manufacturing an illuminating system, the method comprising providing a light guide having a forward surface and a rearward surface; disposing spaced-apart regions of medium over the forward or rearward surface; and disposing a material different from the medium between adjacent spaced-apart regions. Each spaced-apart region includes diffractive features configured to redirect at least some of the light propagating through the light guide out of the light guide.

In various implementations of the method, the spaced-apart regions of medium can be disposed by forming a patterned layer over the forward or the rearward surface of the light guide. The patterned layer can include a plurality of openings therein. A photopolymer can be deposited into the plurality of openings. The patterned layer can be removed to form a plurality of spaced-apart regions of the photopolymer. In various implementations of the method, holographic features can be formed in the plurality of spaced-apart regions of the photopolymer.

In some implementations of the method, the spaced-apart regions of medium can be disposed by providing a sheet of a polymer material and printing or embossing spaced-apart regions on the sheet. The spaced-apart regions can include diffractive features. The sheet can be laminated on the forward or rearward surface of the light guide.

Details of one or more implementations of the subject matter described in this disclosure are set forth in the accompanying drawings and the description below. Although the examples provided in this disclosure are primarily described in terms of EMS and MEMS-based displays the concepts provided herein may apply to other types of displays such as liquid crystal displays, organic light-emitting diode (“OLED”) displays, and field emission displays. Other features, aspects, and advantages will become apparent from the description, the drawings and the claims. Note that the relative dimensions of the following figures may not be drawn to scale.

### BRIEF DESCRIPTION OF THE DRAWINGS

FIG. 1 illustrates a cross-sectional side view of an implementation of a reflective display device equipped with a frontlight system including a light source, a light guide and a plurality of light redirectors.

FIG. 2A illustrates a cross-sectional side view of an implementation of a light guide including a plurality of spaced-apart regions of a medium, each of the plurality of regions including a plurality of diffractive features.

FIG. 2B is a top view of an implementation of a light guide similar to the implementation illustrated in FIG. 2A.

FIG. 2C illustrates a cross-sectional side view of an implementation of a light guide similar to the implementation illustrated in FIG. 2A and further including one or more cladding layers.

FIGS. 3A1-3A3, 3B and 3C illustrate a method of manufacturing a light guide including spaced-apart regions or media with holographic features.

FIG. 4 is a flowchart that illustrates an implementation of a method 400 of manufacturing an illumination system including a plurality of spaced-apart regions of media with diffractive features as described above.

FIGS. 5A1-5B2 show a variation in sizes of the spaced-apart regions of media including diffractive features and the flux of the redirected light for two different lengths of a light guide.

FIG. 6 is an isometric view illustration depicting two adjacent interferometric modulator (IMOD) display elements in a series or array of display elements of an IMOD display device.

FIGS. 7A and 7B are system block diagrams illustrating a display device that includes a plurality of IMOD display elements.

Like reference numbers and designations in the various drawings indicate like elements.

### DETAILED DESCRIPTION

The following description is directed to certain implementations for the purposes of describing the innovative aspects of this disclosure. However, a person having ordinary skill in the art will readily recognize that the teachings herein can be applied in a multitude of different ways. The described implementations may be implemented in any device, apparatus, or system that can be configured to display an image, whether in motion (such as video) or stationary (such as still images), and whether textual, graphical or pictorial. More particularly, it is contemplated that the described implementations may be included in or associated with a variety of electronic devices such as, but not limited to: mobile telephones, multimedia Internet enabled cellular telephones, mobile television receivers, wireless devices, smartphones, Bluetooth® devices, personal data assistants (PDAs), wireless electronic mail receivers, hand-held or portable computers, netbooks, notebooks, smartbooks, tablets, printers, copiers, scanners, facsimile devices, global positioning system (GPS) receivers/navigators, cameras, digital media players (such as MP3 players), camcorders, game consoles, wrist watches, clocks, calculators, television monitors, flat panel displays, electronic reading devices (e.g., e-readers), computer monitors, auto displays (including odometer and speedometer displays, etc.), cockpit controls and/or displays, camera view displays (such as the display of a rear view camera in a vehicle), electronic photographs, electronic billboards or signs, projectors, architectural structures, microwaves, refrigerators, stereo systems, cassette recorders or players, DVD players, CD players, VCRs, radios, portable memory chips, washers, dryers, washer/dryers, parking meters, packaging (such as in electromechanical systems (EMS) applications including microelectromechanical systems (MEMS) applications, as well as non-EMS applications), aesthetic structures (such as display of images on a piece of jewelry or clothing) and a variety of EMS devices. The teachings herein also can be used in non-display applications such as, but not limited to, electronic switching devices, radio frequency filters, sensors, accelerometers, gyroscopes, motion-sensing devices, magnetometers, inertial components for consumer electronics, parts of consumer electronics products, varactors, liquid crystal devices, electrophoretic devices, drive schemes, manufacturing processes and electronic test equipment. Thus, the teachings are not intended to be limited to the implementations depicted solely in the Figures, but instead have wide applicability as will be readily apparent to one having ordinary skill in the art.

Systems and methods that provide illumination are described in this application. Implementations of the illumination systems described herein include a light guide extending in a longitudinal direction and having a transverse direction that is orthogonal to the longitudinal direction. The light guide has a thickness measured along a vertical direction that is orthogonal to the longitudinal and the transverse directions. The illumination systems also include a light source that is configured to inject light into the light guide. The injected light is guided in the light guide by total internal reflection (TIR) at forward and rearward surfaces of the light guide. The TIR allows the light to generally propagate internally through the light guide in the longitudinal direction. Redirectors including diffractive features such as, for example, surface and volume holograms are provided on the forward and/or rearward surface of the light guide to redirect light out of one of the forward or rearward surfaces. The illumination systems described herein may be integrated with implementations of display devices, such that the light redirected out the light guide can be used to illuminate the display devices. In some implementations, the display devices can be reflective display devices, including display devices having a display surface that is specularly reflecting, such as, for example, IMOD-based reflective display devices.

The diffractive features are part of medium that forms a plurality of spaced-apart regions that are spaced-apart from each other by areas that are devoid of that medium. In some implementations, the spaced-apart regions can be discrete islands. In some other implementations, one or more of the spaced-apart regions of a medium can be connected together at some points. For example, the one or more spaced-apart regions can be joined at one or more edges, or otherwise contact one another. In some implementations, a material different from the material of the spaced-apart regions can be disposed in the areas between adjacent spaced-apart regions. The material disposed between the adjacent spaced-apart regions can have a refractive index lower than a refractive index of the light guide, such that it functions as a cladding layer that reflects light travelling longitudinally in the light guide by total internal reflection.

Particular implementations of the subject matter described in this disclosure can be implemented to realize one or more of the following potential advantages. Illuminations systems including light guides with diffractive features as described herein can advantageously redirect light incident in a range of incident angles along a direction that is normal to the surface of the light guide or at angles (e.g., less than or equal to about 10 degrees) close to the normal to the light guide surface. Illumination systems that direct light out at angles along a normal direction to the surface of the light guide or at angles close to the normal direction to the light guide surface can increase the perceived illumination efficiency of the system by providing much of the light within a focused cone. Additionally, the diffractive features can be configured to be highly selective for the direction and wavelength of incidence, which can reduce undesired interactions with light they are not configured to redirect, which can reduce visual artifacts that may be caused by other types of less selective redirectors such as, for example, prismatic features or facets. Diffractive features can have reduced scattering at the edges of the features as compared to other redirectors, such as, for example, prismatic features or facets. Accordingly, implementations of the illumination system including diffractive features as light redirectors can have reduced glare due to reductions in such scattering, which can also provide a high contrast ratio. Furthermore, the diffractive features can be configured to provide various angular distributions of the redirected light which may be advantageous in achieving different illumination patterns.

Diffractive features can be fabricated in materials that are less lossy (that is, less light is lost to unintended absorption or scattering) as compared to materials used to fabricate facets or prismatic features. Nevertheless, light propagating through the light guide can suffer optical loss due to repeated interaction with the diffractive features and possible trapping of light within the layer containing the diffractive features. This optical loss suffered by light as it propagates through the light guide can result in reducing the amount of light that is redirected toward the rearward surface of the light guide as the distance from the light source increases thereby causing a non-uniform distribution of light across the light guide.

Various implementations of the illumination systems described herein can include a plurality of spaced-apart regions of media, each of the plurality of spaced-apart regions of media including a plurality of diffractive features. Providing the diffractive features in a plurality of spaced-apart regions of media can advantageously reduce optical loss incurred by the light propagating through the light guide, by reducing the interaction between the light propagating through the light guide and the diffractive features and media containing the features. Reducing this optical loss can advantageously increase the amount of light that is redirected out of the light guide, which can increase the illumination efficiency and brightness of the illumination system. Additionally, reducing the optical loss incurred during propagation can also increase the uniformity of the light distribution across the surface of the light guide. This can also advantageously increase the size of an area that can be illuminated by the illumination system. In various implementations, the shape and the density of distribution of the spaced-apart regions can be varied to change the distribution of light output by the illumination system. For example, the spaced-apart regions of media including diffractive features may be sparsely distributed closer to the light source and densely distributed away from the light source to achieve an uniform distribution of light across a wider area. As another example, the spaced-apart regions of media including diffractive features can be curved or rounded, as seen in a top-down view, to reduce undesirable scattering of light. Furthermore, the shape and orientation of the spaced-apart regions of media including diffractive features can be selected as desired, for example, to increase efficiency of light extraction and/or reduce visual artifacts.

Various implementations of a reflective display device including IMOD based display elements can be integrated with an illumination system including facets in glass. To achieve a compact display, the facets can be fabricated on an opposite side of the substrate on which the display elements are fabricated by using a method such as a double-side micro-fabrication process. Methods such as double-side micro-fabrication process may be unreliable resulting in a decrease in the yield, expensive and/or complicated. In contrast, the spaced-apart regions of media with diffractive features can be fabricated on a thin plastic or a glass substrate using micro-fabrication techniques. The plastic or glass substrate can have a thickness that is less than 100 μm. For example, in various implementations, the plastic or glass substrate can have a thickness less than 50 μm; less than 30 μm; less than 25 μm; less than 15 μm; less than 10 μm; or less than 5 μm. The thin plastic or glass substrate can be laminated on an opposite side of the substrate on which the display elements are fabricated to achieve a compact display. This method may be more reliable resulting in a higher manufacturing yield, less expensive and less complicated than double-side micro-fabrication process discussed above. Additionally various implementations of the illumination system can be thin, flexible and/or light weight.

Various implementations described herein can be used in a variety of application that include light extraction such as, for example, frontlights or backlights for displays, luminaires, optical touch sensing devices, etc.

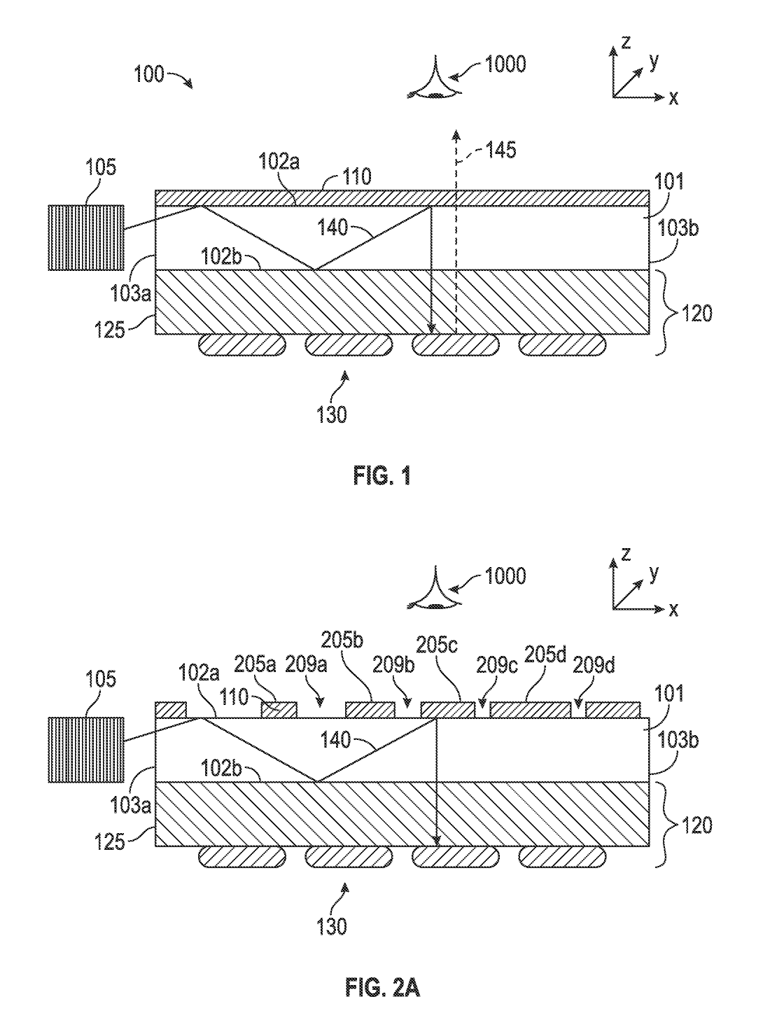

Various implementations described herein can be used to provide front illumination for reflective displays or back illumination for transmissive displays. As discussed herein, for otherwise similar systems, providing light redirectors in spaced-apart regions of media can provide advantages not found in light redirectors disposed in a continuous layer of material. For comparison, a system similar to various implementations disclosed herein, but with light redirectors formed in a continuous layer of material will first be discussed. FIG. 1 illustrates a cross-sectional side view of an implementation of a reflective display device 100 equipped with a frontlight system including a light source 105, a light guide 101, and a plurality of light redirectors 110. The display device 100 includes a reflective display panel 120 having a plurality of reflective display elements 130. The display elements 130 can form the active areas of the display device 100. In various implementations, the reflective display elements 130 can include liquid crystal devices (LCDs), or electrophoretic devices. In various other implementations, the display elements 130 can include electromechanical systems devices, such as, for example, IMOD devices, such as disclosed herein with reference to FIG. 6. In some implementations, the reflective display panel 120 can include a substrate 125. The substrate 125 can be disposed forward or rearward of the plurality of display elements 130 and can provide structural support to the display elements 130. In various implementations, the plurality of display elements 130 can be manufactured on the substrate 125. In those implementations where the substrate 125 is disposed forward of the plurality of reflective display elements 130, such as the implementation 100 depicted in FIG. 1, the substrate 125 is at least partially transmissive to light in the visible spectral range so as to enable a viewer to view the plurality of display elements 130 through the substrate 125. In such implementations, the substrate 125 can include a transmissive material such as glass or plastic. Various implementations of the reflective display panel 120 can include a diffuser (not shown) that is configured to diffuse the light reflected from the plurality of display elements 130. In some implementations, the diffuser can be disposed between the substrate 125 and the plurality of display elements 130. In some implementations, the diffuser can be disposed forward of the substrate 125. In some implementations, the reflective display 120 can include other optical elements such as optical filters, optical isolation layers, polarizers, etc.

With continued reference to FIG. 1, the light guide 101 is disposed forward of the reflective display panel 120, closer to the viewer 1000 than the reflective display panel 120. The light guide 101 has a rearward surface 102b facing the display panel 120 and a forward surface 102a opposite the rearward surface. The light guide 101 can include a plurality of edges 103a and 103b between the forward and the rearward surfaces 102a and 102b. In some implementations, the light guide 101 can be planar such that the forward and rearward surfaces 102a and 102b are parallel to each other. However, in some other implementations, the forward and rearward surfaces 102a and 102b may be non-parallel. For example, the light guide 101 can be wedge-shaped such that the forward and rearward surfaces 102a and 102b are disposed at an angle with respect to each other. The light guide 101 is made of a transmissive material such as glass or plastic having a refractive index n_{g} that is greater than the refractive index of the surrounding medium, which can be air. The light guide 101 can be rigid or flexible. In various implementations, the thickness (for example in the z-direction) of the light guide 101 can be in the range between about 0.5 mm and about 1 mm. In various implementations, the length (along the x-direction) and the width (in the y-direction) of the light guide 101 can be between about 20 times to about 10,000 times the average thickness of the light guide 101.

The light source 105 can include a light emitting diode (LED), cold cathode tube, fluorescent bulb, or any other source of illumination. Without any loss of generality, the light source 105 can be an incoherent light source capable of generating broadband light that includes a wide range of wavelengths. For example, the light source 105 can be configured to emit light in the wavelength range from about 400 μm to about 750 μm. As another example, the light source 105 can be configured to emit light in the wavelength range from about 400 μm to about 1.0 mm. In some other implementations, the light source 105 can be a “coherent” light source which emits light in a limited range of wavelengths.

The light source 105 is disposed with respect to the light guide 101 and configured to inject light into the light guide 101. Various optical coupling elements such as lenses, prisms, light pipes, etc. can be used to condition light from the light source 105 before injecting into the light guide 101. In various implementations, the light source 105 can be disposed adjacent an edge 103a of the light guide 101 such that light from the light source 105 is injected into the light guide 101 through the edge 103a. Some of the light that is injected into the light guide 101 propagates through the light guide 101 by TIR between the forward and rearward surfaces. In various implementations, the plurality of light redirectors 110 are configured to disrupt the propagation of light through the light guide 101 and direct the injected light toward the plurality of display elements 130, as depicted by ray 140 in FIG. 1. Light incident on the plurality of display elements 130 is modulated by the display element 130 and directed out of the display device 100 towards the viewer 1000, as depicted by ray 145 in FIG. 1.

In various implementations, the plurality of light redirectors 110 can include diffractive features. For example, the plurality of redirectors 110 can include surface or volume holograms. In some implementations, the plurality of redirectors 110 can be formed on the forward or rearward surface of the light guide 101.

The diffractive redirectors 110 can provide various advantages over other types of light redirectors, such as prismatic features or facets. For example, because prismatic features or facets may provide specular reflection of light from a wide range of incident angles, the angles of reflected light may also vary in a wide range. Thus, the light propagating through the light guide 101 may not be redirected by the prismatic features or facets such that it is incident on the reflective display panel 120 along a normal direction or at angles close to the normal direction, or other direction matching the desired angle of incident light for the display elements 130 of the display panel 120. This can result in a reduction in the illumination efficiency. Furthermore, the prismatic features or facets may also obscure or reduce light incident on the reflective display panel 120 or the light reflected from the reflective display panel 120, since light traveling from the panel 120 to the viewer 1000 may be unintentionally scattered by the prismatic features or facets. Additionally, the prismatic features or facets may also introduce artifacts that affect the visual appearance of images displayed by the reflective display panel 120. For example, ambient light can be scattered by the prismatic features or facets, which can decrease a contrast ratio of the reflective display panel 120.

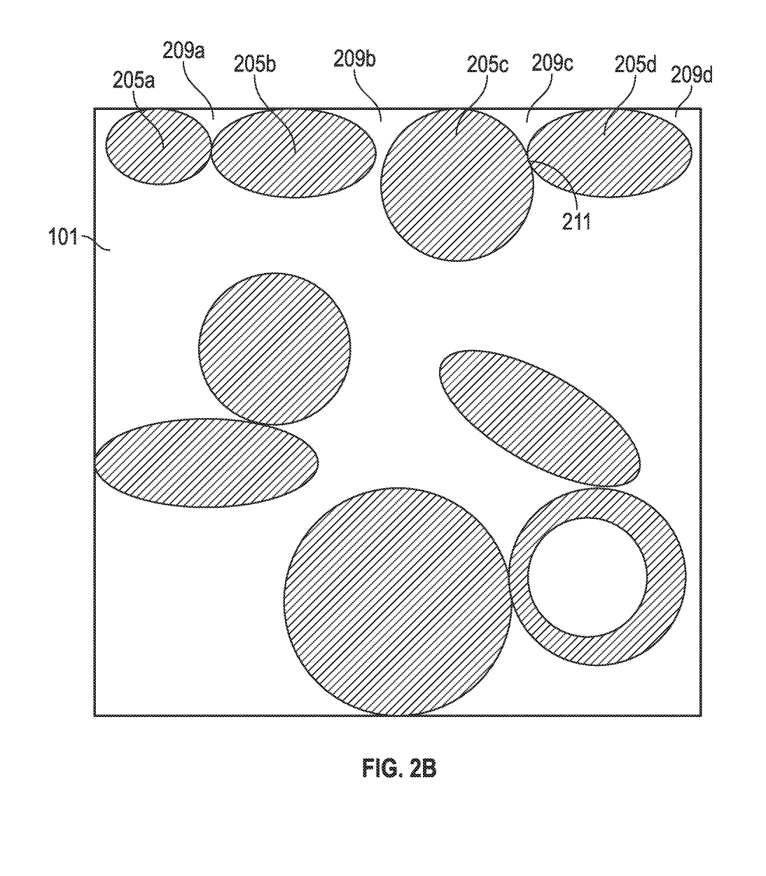

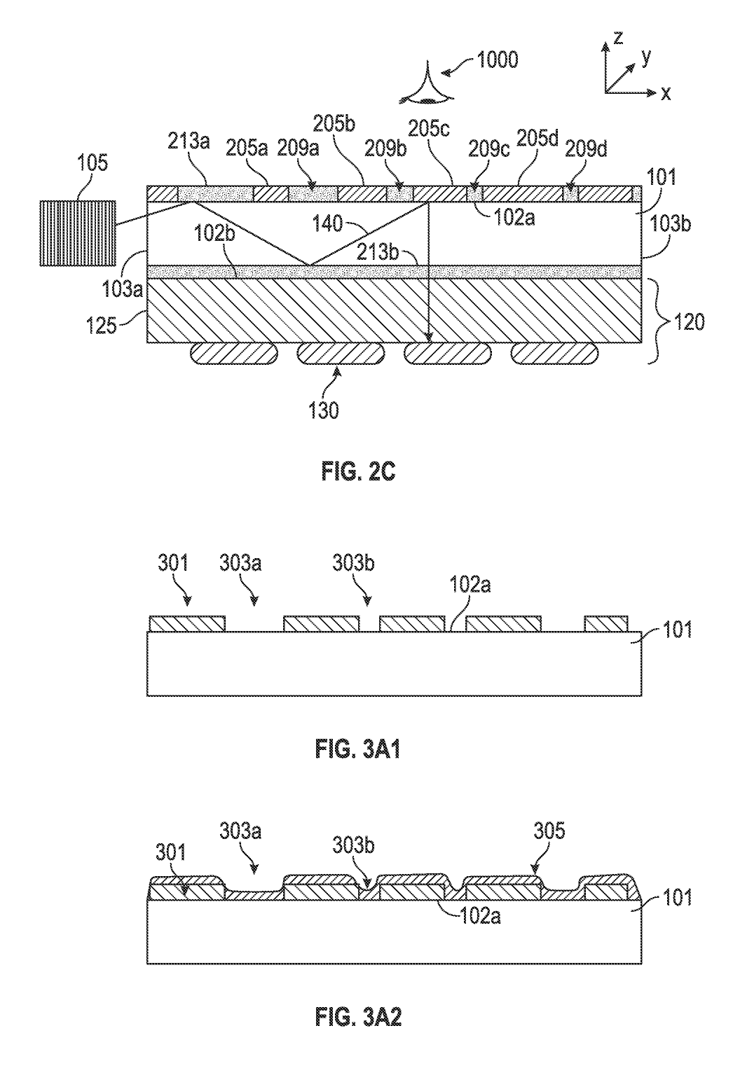

Some of the disadvantages of a light guide including prismatic features or facets discussed above can be overcome by using a light guide 101 including diffractive features. For example, the diffractive features may be configured to redirect light, incident in a range of incident angles, along a normal direction to the forward surface 102a or rearward surface 102b of the light guide 101. It has been found, however, that forming the diffractive features in a continuous layer of material over the forward surface 102a or the rearward surface 102b of the light guide 101 can cause undesirable optical effects. For example, the light propagating through the light guide 101 can suffer optical loss due to repeated interactions with the diffractive features as it propagates through the light guide 101. In addition, a portion of the light propagating through the light guide 101 can be absorbed in the layer including the diffractive features at every bounce. The optical loss suffered by light as it propagates through the light guide 101 can result in reducing the amount of light that is redirected out of the light guide 101, with the reduction increasing as the distance from the light source 105 increases. This loss of light can cause a non-uniform distribution of light across the light guide 101, with the intensity of light greater closer to the light source 105 than farther from the light source 105. The optical loss suffered by light as it propagates through the light guide 101 due to repeated interactions with the diffractive features can be reduced by providing spaced-apart regions of media including the diffractive features as discussed in detail with reference to FIG. 2A.

FIG. 2A illustrates an implementation of a light guide 101 including a plurality of spaced-apart regions 205a, 205b, 205c and 205d of a medium, each of the plurality of regions including a plurality of diffractive features (e.g., diffractive features 110 of FIG. 1). In some implementations, the plurality of diffractive features 110 can be holographic features. FIG. 2B is a top view of an implementation of a light guide 101 similar to the implementation illustrated in FIG. 2A. FIG. 2C illustrates a cross-sectional side view of an implementation of a light guide 101 similar to the implementation illustrated in FIG. 2A and further including one or more cladding layers 213a and 213b. The plurality of regions 205a, 205b, 205c and 205d are spaced-apart from each other by region 209a, 209b, 209c and 209d that are devoid of the media accommodating the diffractive features. Accordingly, the regions 209a-209d are devoid of diffractive features. In some implementations, the plurality of regions 205a, 205b, 205c and 205d can be discrete islands. In some implementations, one or more of the plurality of regions 205a, 205b, 205c and 205d can be connected together at some points. In some implementations, one or more of the plurality of regions 205a, 205b, 205c and 205d can be joined at the edges, or otherwise contact one another. For example, as shown in FIG. 2B, the spaced-apart region 205c and the spaced-apart region 205d are joined along the edge 211.

With reference to FIG. 2B, the regions 205a, 205b, 205c and 205d can have any desired shape and size. In various implementations, the regions 205a-205d can have curved or rounded edges to reduce scattering of light from sharp corners. For example, the regions 205a-205d can be circular, elliptical or annular in shape. As another example, the regions 205a-205d can be a polygon with rounded corners. For example, the regions 205a-205d can be a rounded triangle, a rounded square, a rounded rectangle, a rounded hexagon, etc. In various implementations, the regions 205a-205d can have other arbitrary shapes such as, for example, a triangle, a square, a rectangle, a hexagon, etc.

In various implementations, the shape and the orientation of the regions 205a-205d can be selected to provide high levels of light extraction efficiency and/or low levels of visual artifacts. For example, if one or more of the regions 205a-205d is elliptical, then orienting that region such that a major (longer) axis of the elliptical regions is perpendicular to the direction of light path can increase the amount of light that is redirected by the diffractive features in that region and thus increase efficiency of light extraction. Conversely, providing elliptical regions 205a-205d that are parallel to the direction of light propagation can provide relatively lower levels of light extraction. Thus, in some implementations with substantially elliptical regions 205a-205d, the orientations of the regions may change across the surface of the light guide 101 to achieve desired levels of light extraction efficiency across that the light guide 101. For example, in some implementations, the major axis of the substantially elliptical regions 205a-205d can transition from being relatively more parallel to the direction of light propagation to being increasingly more perpendicular to the direction of light propagation with increasing distance from the light source 105 (FIG. 2A). This can facilitate a more uniform extracted light distribution across the light guide 101, while providing a generally similar density of diffractive features across the light guide 101. This generally similar density may aid in providing a more uniform displayed image in cases were the diffractive features interact with light reflected pass those features from reflective display elements.

The regions 205a, 205b, 205c and 205d may be regularly spaced across the light guide 101, or may be irregularly spaced. In some implementations, irregular spacing can provide benefits for light distribution uniformity and reduction of Moiré effects. For example, the size of the regions 205a, 205b, 205c and 205d may increase and/or their spacing may decrease with distance from the light source 105 (FIG. 2A). This increase in size and/or decrease in spacing can compensate for decreases in the amount of light in the light guide 101 as distances from the light source 105 increase. In various implementations, the spacing between adjacent spaced-apart regions of media 205a, 205b, 205c and 205d can be between about 0.01 mm and about 0.05 mm, between about 0.1 mm and about 0.5 mm, or between about 1 mm and about 2 mm.

In various implementations, a layer 213a including material different from the material of the media forming the plurality of spaced-apart regions 205a, 205b, 205c and 205d can be disposed into one or more of the spaces between regions 209a, 209b, 209c and 209d, as shown in FIG. 2C. The material of layer 213a may be transmissive and may have a refractive index n_{cl} that is lower than the refractive index n_{g} of the material of the light guide 101, such that the layer 213a forms a cladding layer that provides TIR to facilitate propagation of light within the light guide 101. In various implementations, the light guide 101 can include a second cladding layer 213b disposed opposite the layer 213a, for example, under the rearward surface 102b of the light guide 101, to provide TIR of light between the forward surface 102a and the rearward surface 102b of the light guide 101. The second cladding layer 213b can include the same material as the layer 213a. In some implementations, the material forming the cladding layers 213a and 213b can have a refractive index that is about 0.1, about 0.15, or about 0.2 lower than the refractive index of the light guide 101. Examples of materials for forming the cladding layer 213a or 213b include materials sold under the trademark of Riston® by DuPont of Wilmington, Del. Examples of materials for forming the cladding layer 213a or 213b can include photoresist materials sold by companies such as Fujifilm Electronic Materials of North Kingstown, R.I., Hitachi Chemical of Chiyoda, Tokyo, etc.

Since light propagating through the light guide 101 in the implementations illustrated in FIGS. 2A-2C, may not interact with the diffractive features at every point of contact with those features, the optical loss suffered by light propagating through the light guide 101 can be lower as compared to the optical loss suffered by light propagating through a light guide having a continuous layer of diffractive features. Reducing the optical loss incurred due to interaction with the diffractive features during propagation can advantageously increase the amount of light that is redirected out of the light guide 101 and also can increase the uniformity of light distribution across the surface of the light guide 101.

As discussed above, light propagates along the length of the light guide 101 by TIR between the forward and rearward surfaces of the light guide 101. When the light propagating through the light guide 101 strikes a portion of one of the plurality of spaced-apart region 205a, 205b, 205c and 205d, it is redirected out of the light guide 101 by the diffractive features included as part of that spaced-apart region. The diffractive features can be configured to redirect light that is incident in a range of incident angles toward the rearward surface of the light guide 101 along a direction normal to the forward 102a or rearward 102b surface of the light guide 101 or at angles (for example, less than about 30 degrees, less than about 20 degrees, or less than about 10 degrees) close to a desired angle such as the normal to the forward 102a or rearward 102b surface of the light guide 101. For example, light incident in a range of incident angles between about 20 degrees to about 30 degrees; about 30 degrees to about 40 degrees; about 40 degrees to about 50 degrees; about 50 degrees to about 60 degrees; about 60 degrees to about 70 degrees; about 70 degrees to about 80 degrees; and about 80 degrees to about 90 degrees with respect to a normal to the forward surface 102a of the light guide 101 can be redirected by the diffractive features in the plurality of spaced-apart regions 205a, 205b, 205c and 205d along the normal to the forward surface 102a or within a cone including angles of less than about 10 degrees from the normal to the forward surface 102a of the light guide 101. In various implementations, the plurality of diffractive features can be configured to be wavelength selective such that different wavelengths of light are redirected by different groups of the plurality of diffractive features. For example, a first group of the plurality of diffractive features can be configured to redirect incident light in a first wavelength range Δλ₁ centered about a first wavelength λ₁ and a second group of the plurality of diffractive features can be configured to redirect incident light in a second wavelength range Δλ₂ centered about a second wavelength λ₂. The first wavelength λ₁ and the second wavelength λ₂ can be in the visible spectral range (e.g., about 400 μm-750 μm) and/or in the infrared spectral range (e.g., about 750 μm-1.5 mm). In this manner, in some implementations, the plurality of diffractive features can be configured to redirect broadband incoherent light from the source 105.

As discussed above, the diffractive features can include volume holograms and/or surface holograms. In some of the implementations having volume or surface holograms, the holograms can be formed by recording a desired holographic pattern produced by the interference of two beams on a photosensitive plate, film or layer. One of the two beams is called the reference beam (or output beam) and the other is called the signal beam (or input beam). The two beams are directed into the same holographic media to produce an interference pattern. The interference pattern is recorded on the holographic media (e.g., a photosensitive plate, film or layer) as a modulation or a variation in the refractive index (e.g., volume hologram) of the holographic media. In some other implementations, an interference pattern is formed as topographical features, thereby forming a surface hologram. In some implementations, the interference pattern can be recorded as fringes or grating. In some implementations, holographic features may be printed or embossed on a sheet or layer of a polymer material. The sheet or layer of a polymer material can have a thickness less than 1 mm (e.g., less than or equal to 100 μm; less than or equal to 50 μm; less than or equal to 30 μm; less than or equal to 15 μm; less than or equal to 10 μm; or less than or equal to 5 μm).

The holograms may be formed or recorded so as to act as reflection holograms, which are configured to reflect light, and transmission holograms, which are configured to change the direction of light transmitted through the hologram. In various implementations, each spaced-apart region 205a-205d can include reflection holograms, transmission holograms, or combinations thereof. Since reflection holograms can have higher wavelength sensitivity or selectivity and transmission holograms can have higher angle sensitivity or selectivity, the desired degree of sensitivity to wavelengths or angles of incidence may be chosen by appropriate selection of the use of reflection or transmission holograms. In some implementations, multiplexing reflection and transmission holograms can increase the efficiency of light redirection by the holographic features.

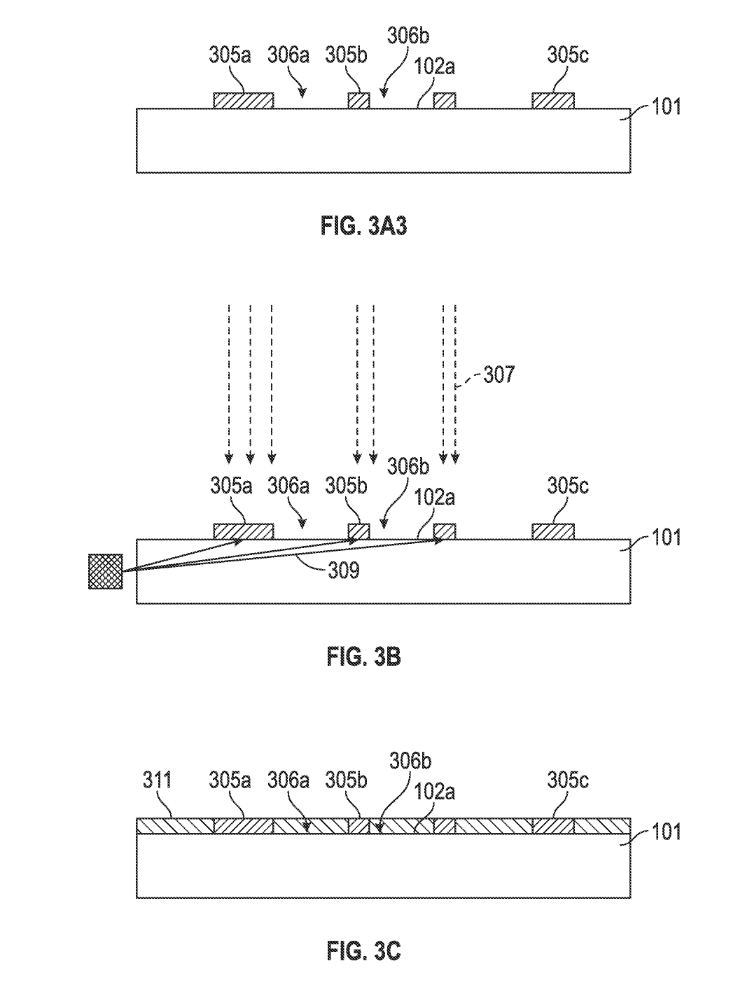

FIGS. 3A1-3A3, 3B and 3C illustrate a method of manufacturing a light guide including spaced-apart regions or media with holographic features. FIGS. 3A1-3A3 illustrate a method to pattern a plurality of spaced-apart regions 305a, 305b and 305c of a medium on the forward surface 102a of the light guide 101. In the illustrated method, a patterning layer 301, having a plurality of openings 303a and 303b, is formed on the forward surface 102a of the light guide 101. The openings 303a and 303b can be formed by various methods, including mechanical processes, such as imprinting, and/or chemical processes, such as chemical etching. A layer 305 of a medium (e.g., a photopolymer) for accommodating light redirectors, such as diffractive features, is deposited over the patterning layer 301 such that the openings 303a and 303b include the medium, as shown in FIG. 3A2. The deposition may be a vapor phase deposition, or liquid phase deposition, such as a spin on deposition. The patterning layer 301 is subsequently removed by using methods such as, for example etching to form a plurality of open spaces 306a and 306b between the spaced-apart regions 305a, 305b and 305c of the forward surface 102a of the light guide 101, as shown in FIG. 3A3. In various implementations, the plurality of spaced-apart regions 305a, 305b and 305c can have a thickness less than 1 mm. For example, in some implementations, the plurality of spaced-apart regions 305a, 305b and 305c can have thickness less than or equal to 500 μm; less than or equal to 100 μm; less than or equal to 50 μm; less than or equal to 30 μm; less than or equal to 15 μm; less than or equal to 10 μm; less than or equal to 5 μm. In various implementations, the plurality of spaced-apart regions 305a, 305b and 305c can have thickness between about 5-25 μm. In some implementations, the open spaces 306a and 306b between the spaced-apart regions 305a, 305b and 305c can have an area between about 10⁻⁴ mm² and about 1 mm² such that the spaced-apart regions 305a, 305b and 305c are distributed over about 5% to about 10% of the area of the light guide 101; about 10% to about 20% of the area of the light guide 101; about 20% to about 30% of the area of the light guide 101; or about 30% to about 40% of the area of the light guide 101.

FIG. 3B illustrates a method of recording holographic features on the patterned plurality of spaced-apart regions 305a, 305b and 305c of the medium. Holographic features can be recorded on the plurality of spaced-apart regions 305a, 305b and 305c of the medium by optically interfering a reference beam 307 with a signal beam 309, as discussed above. The reference beam 307 and/or the signal beam 309 can be generated by a coherent source (e.g., a laser). Since it is desirable for the holographic features to redirect light along a normal direction or close (e.g., at angles less than about 10 degrees) to the normal direction with respect to the forward surface 102a of the light guide 101, the reference beam 307 may be incident on the patterned plurality of spaced-apart regions 305a, 305b and 305c of the medium along the normal direction with respect to the forward surface 102a of the light guide 101. The signal beam 309 can be incident at angles θ₁, θ₂, and θ₃. In some implementations, the angles θ₁, θ₂, and θ₃ can have a value between about 10 degrees-about 20 degrees; about 20 degrees-about 30 degrees; about 30 degrees-about 40 degrees; about 40 degrees-about 50 degrees; about 50 degrees-about 60 degrees; about 60 degrees-about 70 degrees; about 70 degrees-about 80 degrees; about 80 degrees-about 90 degrees with respect to a normal to the forward surface 102a of the light guide 101. Multiple holograms can be recorded on each of the plurality of spaced-apart regions 305a, 305b and 305c of the medium by varying the wavelength and/or the angle of incidence of the signal beam 309 to form multiplexed holograms. For example, in one implementation, a multiplexed hologram can be recorded using three different wavelengths of the signal beam 309 (e.g., red, blue and green) incident at different incident angles (e.g., 30 degrees, 45 degrees, 60 degrees, 80 degrees, etc.). It should be noted that it is not required to change the incident angle of the reference beam 307. However, by changing the incident angle of the reference beam 307, the angle at which light will be redirected out of the light guide 101 can be changed.

These multiplexed holograms can provide selectivity for redirecting light of a desired range of wavelengths and/or angles of incidence. Additionally, the recorded holograms can be configured to reduce or mitigate visual artifacts such as rainbow and coloring differences. For example, in various implementations, lasers configured to output light at different wavelengths (e.g., red, green and blue) at different incident angles can be used to mitigate visual artifacts. In another example, because the wavelength of extracted light may be determined by the wavelength of light from the lasers, the color balance of light extracted from a light guide may be determined by appropriate selection of the wavelengths of incident light.

FIG. 3C illustrates a method of including a layer 311 of material (e.g. a cladding material) different from the material of the patterned plurality of spaced-apart regions 305a, 305b and 305c in the plurality of open spaces 306a and 306b. The material in the layer 311 can have a refractive index that is less than the refractive index of the material of the light guide 101. For example, the material forming the layer 311 can have a refractive index that is about 0.1, about 0.15, or about 0.2 lower than the refractive index of the light guide 101. Examples of materials for forming the layer 311 include optically transparent materials, such as optically transparent polymeric materials. In some implementations, the cladding layer 311 can include materials sold under the trademark of Riston® by DuPont of Wilmington, Del. or other photoresist material. Examples of materials for forming the cladding layer 311 can include photoresist materials sold by companies such as Fujifilm Electronic Materials of North Kingstown, R.I., Hitachi Chemical of Chiyoda, Tokyo, etc. In various implementations, the layer 311 can be formed by manufacturing methods such as physical or chemical vapor deposition methods. Depositing a cladding layer can advantageously confine the propagating light within the light guide 101 and thus reduce light leakage out of the light guide 101. Although, in the implementation illustrated in FIGS. 3B and 3C, the holographic features are formed prior to forming of the layer 311, in other implementations the layer 311 can be formed before forming the holographic features or simultaneously with forming the holographic features.

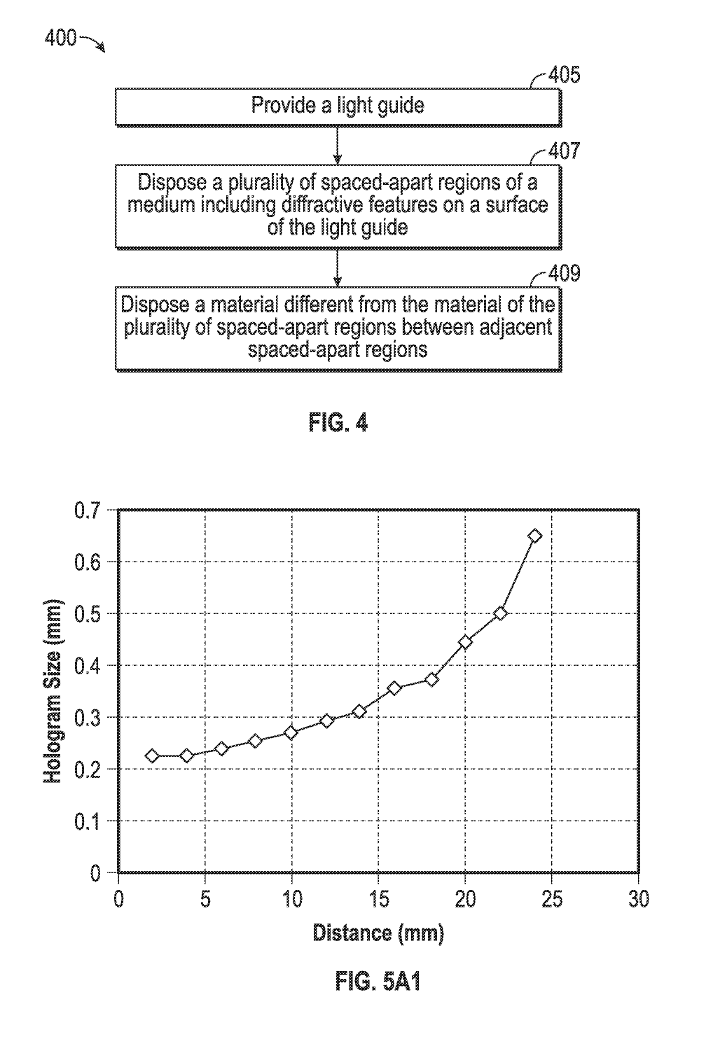

FIG. 4 is a flowchart that illustrates an implementation of a method 400 of manufacturing an illumination system including plurality of spaced-apart regions of media with diffractive features as described above. The method 400 includes providing a light guide similar to the light guide 101 discussed above, as shown in block 405. The method further includes disposing on a surface of the light guide, a plurality of spaced-apart regions of a medium including diffractive features similar to the plurality of spaced-apart regions 205a-205d and 305a-305d discussed above, as shown in block 407. The spaced-apart regions of the medium including diffractive features can be disposed on a forward surface or a rearward surface of the light guide. In some implementations of the method 400, the plurality of spaced-apart regions including diffractive features can be disposed using a manufacturing method similar to the method illustrated in FIGS. 3A1-3A2 and 3B described above. In other implementations of the method 400, the plurality of spaced-apart regions of medium including diffractive features can be printed or embossed on a sheet or roll of a polymer material. The sheet or roll of polymer material including the plurality of spaced-apart regions of medium with diffractive features can be laminated or bonded to a surface of the light guide. The method 400 further includes disposing a material different from the material of the plurality of spaced-apart regions between adjacent spaced-apart regions, as shown in block 409. In various implementations, the material different from the material of the plurality of spaced-apart regions can form a cladding layer, In some implementations, a cladding layer can be disposed on a surface of the light guide opposite to the surface including the plurality of spaced-apart regions. In some implementations, the method 400 further includes providing a display device to the illumination system including the plurality of spaced-apart regions of medium with diffractive features. The display device can be provided by attaching the display device to the illumination system.

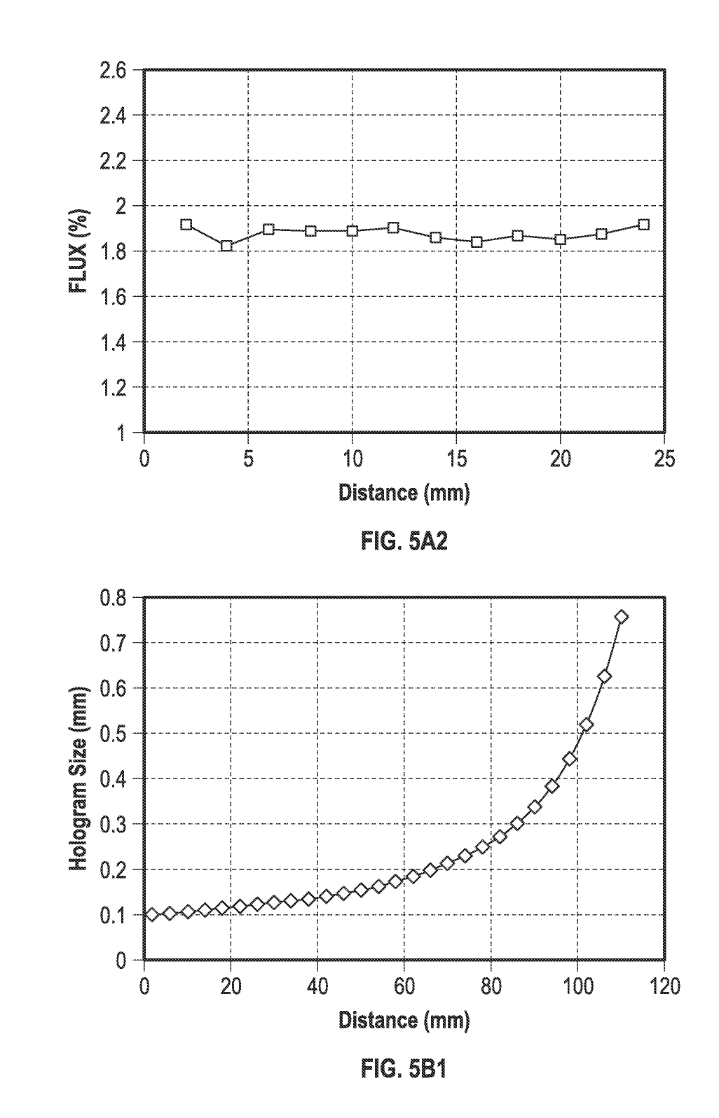

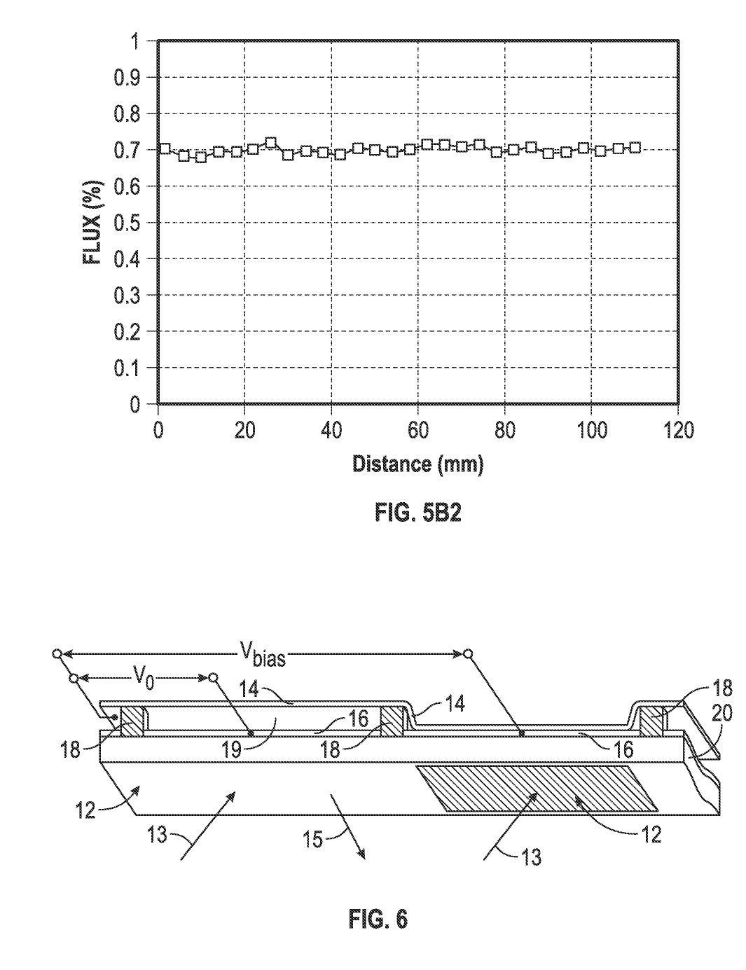

In various implementations of the illumination system discussed above, distribution of light across a surface of the light guide (e.g., light guide 101) can be changed by varying (i) a size of the plurality of spaced-apart regions (e.g., spaced-apart regions 205a-205d); (ii) spacing between adjacent spaced-apart regions (e.g., size of the regions 209a-209d); and/or (iii) density of the diffractive features. For example, in various implementations, the size of the plurality of spaced-apart regions can increase as the distance from the light source (e.g., light source 105) increases to achieve more uniform light distribution across a surface of the light guide. In another example, the spacing between adjacent spaced-apart regions can decrease as the distance from the light source increases to achieve more uniform light distribution across a surface of the light guide. In yet another example, a density of the diffractive features within the spaced-apart regions can increase as the distance from the light source increases to achieve more uniform light distribution across a surface of the light guide. The dependence of the flux of the redirected light across a surface of the light guide on the size and distribution of the plurality of spaced-apart regions of a medium including diffractive features is discussed in further detail below with reference to FIGS. 5A1-5B2.

FIGS. 5A1-5B2 show a variation in a size of the spaced-apart regions of media including diffractive features and the flux of the redirected light for two different lengths of a light guide. FIG. 5A1 shows an implementation of a chocolate-bar sized light guide including a plurality of spaced-apart regions that increase in size as the distance from the light source increases. In some implementations, the light guide depicted in FIG. 5A1 can have a length dimension between about 35 mm to about 40 mm and a width dimensions between about 28 mm and 38 mm. A thickness of the light guide depicted in FIG. 5A1 can be between about 0.3 mm and about 0.7 mm. FIG. 5A2 is a simulated result of the flux of the light redirected by the implementation illustrated in FIG. 5A1. FIG. 5B1 shows an implementation of a kestrel sized light guide including a plurality of spaced-apart regions that increase in size as the distance from the light source increases. In some implementations, the light guide depicted in FIG. 5A1 can have a length dimension between about 110 mm to about 138 mm and a width dimensions between about 65 mm and 85 mm. A thickness of the light guide depicted in FIG. 5A1 can be between about 0.3 mm and about 0.7 mm. FIG. 5B2 is a simulated result of the flux of the light redirected by the implementation illustrated in FIG. 5B1. From FIGS. 5A1 and 5A2 it is observed that the redirected light can have a substantially uniform flux over the length of a light guide by increasing the size of the plurality of spaced-apart regions along the length of the light guide. From FIGS. 5B1 and 5B2, even with the larger size of the light guide for that figure, it is observed that the redirected light can have a substantially uniform flux over the length of a light guide by increasing the size of the plurality of spaced-apart regions.

An example of a suitable EMS or MEMS device or apparatus, to which the above described implementations may apply, is a reflective display device (e.g., reflective display panel 120). Reflective display devices can incorporate interferometric modulator (IMOD) display elements that can be implemented to selectively absorb and/or reflect light incident thereon using principles of optical interference. IMOD display elements can include a partial optical absorber, a reflector that is movable with respect to the absorber, and an optical resonant cavity defined between the absorber and the reflector. In some implementations, the reflector can be moved to two or more different positions, which can change the size of the optical resonant cavity and thereby affect the reflectance of the IMOD. The reflectance spectra of IMOD display elements can create fairly broad spectral bands that can be shifted across the visible wavelengths to generate different colors. The position of the spectral band can be adjusted by changing the thickness of the optical resonant cavity. One way of changing the optical resonant cavity is by changing the position of the reflector with respect to the absorber.

FIG. 6 is an isometric view illustration depicting two adjacent interferometric modulator (IMOD) display elements in a series or array of display elements of an IMOD display device. The IMOD display device includes one or more interferometric EMS, such as MEMS, display elements. In these devices, the interferometric MEMS display elements can be configured in either a bright or dark state. In the bright (“relaxed,” “open” or “on,” etc.) state, the display element reflects a large portion of incident visible light. Conversely, in the dark (“actuated,” “closed” or “off,” etc.) state, the display element reflects little incident visible light. MEMS display elements can be configured to reflect predominantly at particular wavelengths of light allowing for a color display in addition to black and white. In some implementations, by using multiple display elements, different intensities of color primaries and shades of gray can be achieved.

The IMOD display device can include an array of IMOD display elements which may be arranged in rows and columns. Each display element in the array can include at least a pair of reflective and semi-reflective layers, such as a movable reflective layer (i.e., a movable layer, also referred to as a mechanical layer) and a fixed partially reflective layer (i.e., a stationary layer), positioned at a variable and controllable distance from each other to form an air gap (also referred to as an optical gap, cavity or optical resonant cavity). The movable reflective layer may be moved between at least two positions. For example, in a first position, i.e., a relaxed position, the movable reflective layer can be positioned at a distance from the fixed partially reflective layer. In a second position, i.e., an actuated position, the movable reflective layer can be positioned more closely to the partially reflective layer. Incident light that reflects from the two layers can interfere constructively and/or destructively depending on the position of the movable reflective layer and the wavelength(s) of the incident light, producing either an overall reflective or non-reflective state for each display element. In some implementations, the display element may be in a reflective state when unactuated, reflecting light within the visible spectrum, and may be in a dark state when actuated, absorbing and/or destructively interfering light within the visible range. In some other implementations, however, an IMOD display element may be in a dark state when unactuated, and in a reflective state when actuated. In some implementations, the introduction of an applied voltage can drive the display elements to change states. In some other implementations, an applied charge can drive the display elements to change states.

The depicted portion of the array in FIG. 6 includes two adjacent interferometric MEMS display elements in the form of IMOD display elements 12. In the display element 12 on the right (as illustrated), the movable reflective layer 14 is illustrated in an actuated position near, adjacent or touching the optical stack 16. The voltage V_{bias} applied across the display element 12 on the right is sufficient to move and also maintain the movable reflective layer 14 in the actuated position. In the display element 12 on the left (as illustrated), a movable reflective layer 14 is illustrated in a relaxed position at a distance (which may be predetermined based on design parameters) from an optical stack 16, which includes a partially reflective layer. The voltage V₀ applied across the display element 12 on the left is insufficient to cause actuation of the movable reflective layer 14 to an actuated position such as that of the display element 12 on the right.

In FIG. 6, the reflective properties of IMOD display elements 12 are generally illustrated with arrows indicating light 13 incident upon the IMOD display elements 12, and light 15 reflecting from the display element 12 on the left. Most of the light 13 incident upon the display elements 12 may be transmitted through the transparent substrate 20, toward the optical stack 16. A portion of the light incident upon the optical stack 16 may be transmitted through the partially reflective layer of the optical stack 16, and a portion will be reflected back through the transparent substrate 20. The portion of light 13 that is transmitted through the optical stack 16 may be reflected from the movable reflective layer 14, back toward (and through) the transparent substrate 20. Interference (constructive and/or destructive) between the light reflected from the partially reflective layer of the optical stack 16 and the light reflected from the movable reflective layer 14 will determine in part the intensity of wavelength(s) of light 15 reflected from the display element 12 on the viewing or substrate side of the device. In some implementations, the transparent substrate 20 can be a glass substrate (sometimes referred to as a glass plate or panel). The glass substrate may be or include, for example, a borosilicate glass, a soda lime glass, quartz, Pyrex, or other suitable glass material. In some implementations, the glass substrate may have a thickness of 0.3, 0.5 or 0.7 millimeters, although in some implementations the glass substrate can be thicker (such as tens of millimeters) or thinner (such as less than 0.3 millimeters). In some implementations, a non-glass substrate can be used, such as a polycarbonate, acrylic, polyethylene terephthalate (PET) or polyether ether ketone (PEEK) substrate. In such an implementation, the non-glass substrate will likely have a thickness of less than 0.7 millimeters, although the substrate may be thicker depending on the design considerations. In some implementations, a non-transparent substrate, such as a metal foil or stainless steel-based substrate can be used. For example, a reverse-IMOD-based display, which includes a fixed reflective layer and a movable layer which is partially transmissive and partially reflective, may be configured to be viewed from the opposite side of a substrate as the display elements 12 of FIG. 6 and may be supported by a non-transparent substrate.

The optical stack 16 can include a single layer or several layers. The layer(s) can include one or more of an electrode layer, a partially reflective and partially transmissive layer, and a transparent dielectric layer. In some implementations, the optical stack 16 is electrically conductive, partially transparent and partially reflective, and may be fabricated, for example, by depositing one or more of the above layers onto a transparent substrate 20. The electrode layer can be formed from a variety of materials, such as various metals, for example indium tin oxide (ITO). The partially reflective layer can be formed from a variety of materials that are partially reflective, such as various metals (e.g., chromium and/or molybdenum), semiconductors, and dielectrics. The partially reflective layer can be formed of one or more layers of materials, and each of the layers can be formed of a single material or a combination of materials. In some implementations, certain portions of the optical stack 16 can include a single semi-transparent thickness of metal or semiconductor which serves as both a partial optical absorber and electrical conductor, while different, electrically more conductive layers or portions (e.g., of the optical stack 16 or of other structures of the display element) can serve to bus signals between IMOD display elements. The optical stack 16 also can include one or more insulating or dielectric layers covering one or more conductive layers or an electrically conductive/partially absorptive layer.

In some implementations, at least some of the layer(s) of the optical stack 16 can be patterned into parallel strips, and may form row electrodes in a display device as described further below. As will be understood by one having ordinary skill in the art, the term “patterned” is used herein to refer to masking as well as etching processes. In some implementations, a highly conductive and reflective material, such as aluminum (Al), may be used for the movable reflective layer 14, and these strips may form column electrodes in a display device. The movable reflective layer 14 may be formed as a series of parallel strips of a deposited metal layer or layers (orthogonal to the row electrodes of the optical stack 16) to form columns deposited on top of supports, such as the illustrated posts 18, and an intervening sacrificial material located between the posts 18. When the sacrificial material is etched away, a defined gap 19, or optical cavity, can be formed between the movable reflective layer 14 and the optical stack 16. In some implementations, the spacing between posts 18 may be approximately 1-1000 μm, while the gap 19 may be approximately less than 10,000 Angstroms (Å).

In some implementations, each IMOD display element, whether in the actuated or relaxed state, can be considered as a capacitor formed by the fixed and moving reflective layers. When no voltage is applied, the movable reflective layer 14 remains in a mechanically relaxed state, as illustrated by the display element 12 on the left in FIG. 6, with the gap 19 between the movable reflective layer 14 and optical stack 16. However, when a potential difference, i.e., a voltage, is applied to at least one of a selected row and column, the capacitor formed at the intersection of the row and column electrodes at the corresponding display element becomes charged, and electrostatic forces pull the electrodes together. If the applied voltage exceeds a threshold, the movable reflective layer 14 can deform and move near or against the optical stack 16. A dielectric layer (not shown) within the optical stack 16 may prevent shorting and control the separation distance between the layers 14 and 16, as illustrated by the actuated display element 12 on the right in FIG. 6. The behavior can be the same regardless of the polarity of the applied potential difference. Though a series of display elements in an array may be referred to in some instances as “rows” or “columns,” a person having ordinary skill in the art will readily understand that referring to one direction as a “row” and another as a “column” is arbitrary. Restated, in some orientations, the rows can be considered columns, and the columns considered to be rows. In some implementations, the rows may be referred to as “common” lines and the columns may be referred to as “segment” lines, or vice versa. Furthermore, the display elements may be evenly arranged in orthogonal rows and columns (an “array”), or arranged in non-linear configurations, for example, having certain positional offsets with respect to one another (a “mosaic”). The terms “array” and “mosaic” may refer to either configuration. Thus, although the display is referred to as including an “array” or “mosaic,” the elements themselves need not be arranged orthogonally to one another, or disposed in an even distribution, in any instance, but may include arrangements having asymmetric shapes and unevenly distributed elements. Implementations of the illumination system described herein can be disposed over the substrate 20 in order to provide front illumination to the IMOD display elements 12.

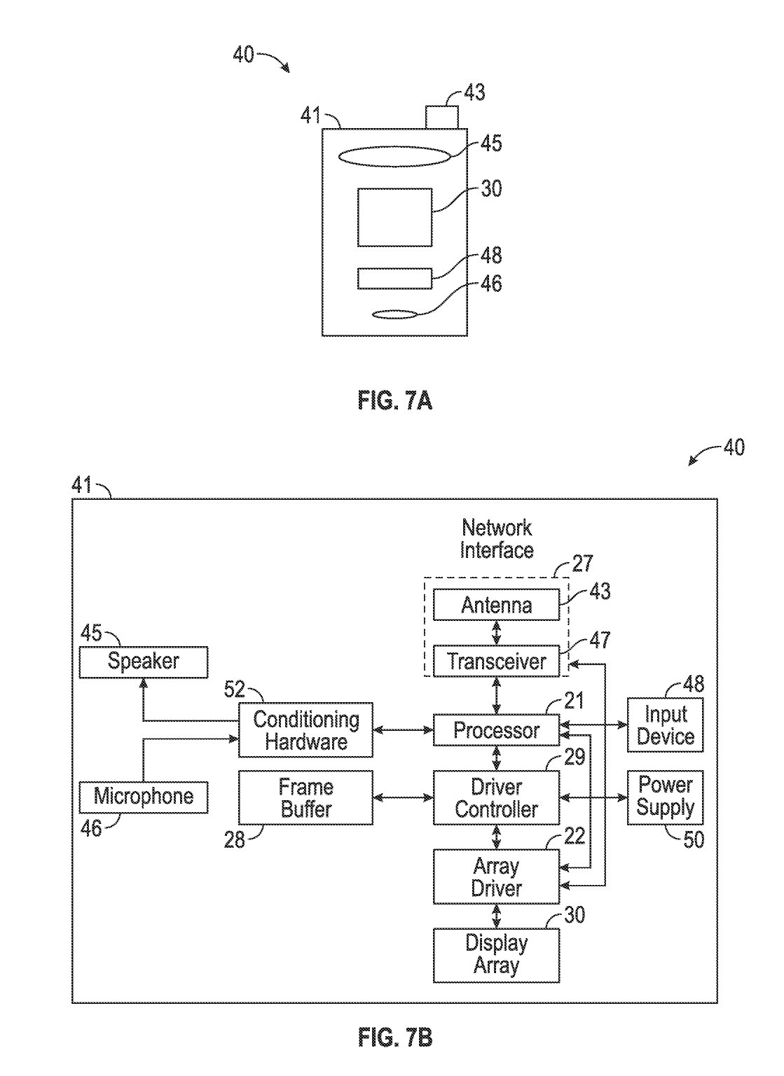

FIGS. 7A and 7B are system block diagrams illustrating a display device 40 that includes a plurality of IMOD display elements (e.g., display elements 12). The display device 40 can be, for example, a smart phone, a cellular or mobile telephone. However, the same components of the display device 40 or slight variations thereof are also illustrative of various types of display devices such as televisions, computers, tablets, e-readers, hand-held devices and portable media devices.

The display device 40 includes a housing 41, a display 30, an antenna 43, a speaker 45, an input device 48 and a microphone 46. The housing 41 can be formed from any of a variety of manufacturing processes, including injection molding, and vacuum forming. In addition, the housing 41 may be made from any of a variety of materials, including, but not limited to: plastic, metal, glass, rubber and ceramic, or a combination thereof. The housing 41 can include removable portions (not shown) that may be interchanged with other removable portions of different color, or containing different logos, pictures, or symbols.

The display 30 may be any of a variety of displays, including a bi-stable or analog display, as described herein. The display 30 also can be configured to include a flat-panel display, such as plasma, EL, OLED, STN LCD, or TFT LCD, or a non-flat-panel display, such as a CRT or other tube device. In addition, the display 30 can include an IMOD-based display, as described herein.

The components of the display device 40 are schematically illustrated in FIG. 7A. The display device 40 includes a housing 41 and can include additional components at least partially enclosed therein. For example, the display device 40 includes a network interface 27 that includes an antenna 43 which can be coupled to a transceiver 47. The network interface 27 may be a source for image data that could be displayed on the display device 40. Accordingly, the network interface 27 is one example of an image source module, but the processor 21 and the input device 48 also may serve as an image source module. The transceiver 47 is connected to a processor 21, which is connected to conditioning hardware 52. The conditioning hardware 52 may be configured to condition a signal (such as filter or otherwise manipulate a signal). The conditioning hardware 52 can be connected to a speaker 45 and a microphone 46. The processor 21 also can be connected to an input device 48 and a driver controller 29. The driver controller 29 can be coupled to a frame buffer 28, and to an array driver 22, which in turn can be coupled to a display array 30. One or more elements in the display device 40, including elements not specifically depicted in FIG. 7A, can be configured to function as a memory device and be configured to communicate with the processor 21. In some implementations, a power supply 50 can provide power to substantially all components in the particular display device 40 design.

The network interface 27 includes the antenna 43 and the transceiver 47 so that the display device 40 can communicate with one or more devices over a network. The network interface 27 also may have some processing capabilities to relieve, for example, data processing requirements of the processor 21. The antenna 43 can transmit and receive signals. In some implementations, the antenna 43 transmits and receives RF signals according to the IEEE 16.11 standard, including IEEE 16.11(a), (b), or (g), or the IEEE 802.11 standard, including IEEE 802.11a, b, g, n, and further implementations thereof. In some other implementations, the antenna 43 transmits and receives RF signals according to the Bluetooth® standard. In the case of a cellular telephone, the antenna 43 can be designed to receive code division multiple access (CDMA), frequency division multiple access (FDMA), time division multiple access (TDMA), Global System for Mobile communications (GSM), GSM/General Packet Radio Service (GPRS), Enhanced Data GSM Environment (EDGE), Terrestrial Trunked Radio (TETRA), Wideband-CDMA (W-CDMA), Evolution Data Optimized (EV-DO), 1×EV-DO, EV-DO Rev A, EV-DO Rev B, High Speed Packet Access (HSPA), High Speed Downlink Packet Access (HSDPA), High Speed Uplink Packet Access (HSUPA), Evolved High Speed Packet Access (HSPA+), Long Term Evolution (LTE), AMPS, or other known signals that are used to communicate within a wireless network, such as a system utilizing 3G, 4G or 5G technology. The transceiver 47 can pre-process the signals received from the antenna 43 so that they may be received by and further manipulated by the processor 21. The transceiver 47 also can process signals received from the processor 21 so that they may be transmitted from the display device 40 via the antenna 43.

In some implementations, the transceiver 47 can be replaced by a receiver. In addition, in some implementations, the network interface 27 can be replaced by an image source, which can store or generate image data to be sent to the processor 21. The processor 21 can control the overall operation of the display device 40. The processor 21 receives data, such as compressed image data from the network interface 27 or an image source, and processes the data into raw image data or into a format that can be readily processed into raw image data. The processor 21 can send the processed data to the driver controller 29 or to the frame buffer 28 for storage. Raw data typically refers to the information that identifies the image characteristics at each location within an image. For example, such image characteristics can include color, saturation and gray-scale level.

The processor 21 can include a microcontroller, CPU, or logic unit to control operation of the display device 40. The conditioning hardware 52 may include amplifiers and filters for transmitting signals to the speaker 45, and for receiving signals from the microphone 46. The conditioning hardware 52 may be discrete components within the display device 40, or may be incorporated within the processor 21 or other components.

The driver controller 29 can take the raw image data generated by the processor 21 either directly from the processor 21 or from the frame buffer 28 and can re-format the raw image data appropriately for high speed transmission to the array driver 22. In some implementations, the driver controller 29 can re-format the raw image data into a data flow having a raster-like format, such that it has a time order suitable for scanning across the display array 30. Then the driver controller 29 sends the formatted information to the array driver 22. Although a driver controller 29, such as an LCD controller, is often associated with the system processor 21 as a stand-alone Integrated Circuit (IC), such controllers may be implemented in many ways. For example, controllers may be embedded in the processor 21 as hardware, embedded in the processor 21 as software, or fully integrated in hardware with the array driver 22.

The array driver 22 can receive the formatted information from the driver controller 29 and can re-format the video data into a parallel set of waveforms that are applied many times per second to the hundreds, and sometimes thousands (or more), of leads coming from the display's x-y matrix of display elements.

In some implementations, the driver controller 29, the array driver 22, and the display array 30 are appropriate for any of the types of displays described herein. For example, the driver controller 29 can be a conventional display controller or a bi-stable display controller (such as an IMOD display element controller). Additionally, the array driver 22 can be a conventional driver or a bi-stable display driver (such as an IMOD display element driver). Moreover, the display array 30 can be a conventional display array or a bi-stable display array (such as a display including an array of IMOD display elements). In some implementations, the driver controller 29 can be integrated with the array driver 22. Such an implementation can be useful in highly integrated systems, for example, mobile phones, portable-electronic devices, watches or small-area displays.

In some implementations, the input device 48 can be configured to allow, for example, a user to control the operation of the display device 40. The input device 48 can include a keypad, such as a QWERTY keyboard or a telephone keypad, a button, a switch, a rocker, a touch-sensitive screen, a touch-sensitive screen integrated with the display array 30, or a pressure- or heat-sensitive membrane. The microphone 46 can be configured as an input device for the display device 40. In some implementations, voice commands through the microphone 46 can be used for controlling operations of the display device 40.

The power supply 50 can include a variety of energy storage devices. For example, the power supply 50 can be a rechargeable battery, such as a nickel-cadmium battery or a lithium-ion battery. In implementations using a rechargeable battery, the rechargeable battery may be chargeable using power coming from, for example, a wall socket or a photovoltaic device or array. Alternatively, the rechargeable battery can be wirelessly chargeable. The power supply 50 also can be a renewable energy source, a capacitor, or a solar cell, including a plastic solar cell or solar-cell paint. The power supply 50 also can be configured to receive power from a wall outlet.

In some implementations, control programmability resides in the driver controller 29 which can be located in several places in the electronic display system. In some other implementations, control programmability resides in the array driver 22. The above-described optimization may be implemented in any number of hardware and/or software components and in various configurations.

As used herein, a phrase referring to “at least one of” a list of items refers to any combination of those items, including single members. As an example, “at least one of: a, b, or c” is intended to cover: a, b, c, a-b, a-c, b-c, and a-b-c.

The various illustrative logics, logical blocks, modules, circuits and algorithm steps described in connection with the implementations disclosed herein may be implemented as electronic hardware, computer software, or combinations of both. The interchangeability of hardware and software has been described generally, in terms of functionality, and illustrated in the various illustrative components, blocks, modules, circuits and steps described above. Whether such functionality is implemented in hardware or software depends upon the particular application and design constraints imposed on the overall system.

The hardware and data processing apparatus used to implement the various illustrative logics, logical blocks, modules and circuits described in connection with the aspects disclosed herein may be implemented or performed with a general purpose single- or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, or, any conventional processor, controller, microcontroller, or state machine. A processor also may be implemented as a combination of computing devices, such as a combination of a DSP and a microprocessor, a plurality of microprocessors, one or more microprocessors in conjunction with a DSP core, or any other such configuration. In some implementations, particular steps and methods may be performed by circuitry that is specific to a given function.

In one or more aspects, the functions described may be implemented in hardware, digital electronic circuitry, computer software, firmware, including the structures disclosed in this specification and their structural equivalents thereof, or in any combination thereof. Implementations of the subject matter described in this specification also can be implemented as one or more computer programs, i.e., one or more modules of computer program instructions, encoded on a computer storage media for execution by, or to control the operation of, data processing apparatus.

Various modifications to the implementations described in this disclosure may be readily apparent to those skilled in the art, and the generic principles defined herein may be applied to other implementations without departing from the spirit or scope of this disclosure. Thus, the claims are not intended to be limited to the implementations shown herein, but are to be accorded the widest scope consistent with this disclosure, the principles and the novel features disclosed herein. Additionally, a person having ordinary skill in the art will readily appreciate, the terms “upper” and “lower” are sometimes used for ease of describing the figures, and indicate relative positions corresponding to the orientation of the figure on a properly oriented page, and may not reflect the proper orientation of, e.g., an IMOD display element as implemented.

Certain features that are described in this specification in the context of separate implementations also can be implemented in combination in a single implementation. Conversely, various features that are described in the context of a single implementation also can be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, a person having ordinary skill in the art will readily recognize that such operations need not be performed in the particular order shown or in sequential order, or that all illustrated operations be performed, to achieve desirable results. Further, the drawings may schematically depict one more example processes in the form of a flow diagram. However, other operations that are not depicted can be incorporated in the example processes that are schematically illustrated. For example, one or more additional operations can be performed before, after, simultaneously, or between any of the illustrated operations. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products. Additionally, other implementations are within the scope of the following claims. In some cases, the actions recited in the claims can be performed in a different order and still achieve desirable results.

What is claimed is:

1. An illumination system comprising:
a light guide having forward and rearward surfaces;
a light source configured to inject light into the light guide such that the injected light propagates through at least a portion of the light guide by total internal reflection at one or both of the forward and rearward surfaces;
spaced-apart regions of medium disposed over the forward or rearward surface, each spaced-apart region including diffractive features configured to redirect at least some of the light propagating internally through the light guide out of the light guide; and
a material different from the medium, the material disposed between adjacent spaced-apart regions.

2. The system of claim 1, wherein the diffractive features include holograms.

3. The system of claim 2, wherein the holograms include at least one of a reflection hologram and a transmission hologram.

4. The system of claim 2, wherein the holograms include at least one of a volume hologram and a surface hologram.

5. The system of claim 1, wherein the diffractive features are configured to redirect light out of the light guide along a direction normal to the forward or rearward surface of the light guide.

6. The system of claim 1, wherein the diffractive features are configured to redirect light out of the light guide at an angle less than about 10 degrees from a normal to the forward or rearward surface of the light guide.

7. The system of claim 1, wherein the diffractive features include a first group of diffractive features configured to redirect light in a first wavelength range Δλ₁ centered about a first wavelength λ₁ and a second group of diffractive features configured to redirect light in a second wavelength range Δλ₂ centered about a second wavelength λ₂.

8. The system of claim 1, wherein the material between adjacent spaced-apart regions is devoid of diffractive features.

9. The system of claim 1, wherein the spaced-apart regions of medium include a photopolymer.

10. The system of claim 1, wherein the material between adjacent spaced-apart regions has a refractive index lower than a refractive index of the light guide.

11. A display apparatus comprising a display and the illumination system of claim 1.

12. The display apparatus of claim 11, wherein the display is a reflective display facing the rearward surface of the light guide.

13. The display apparatus of claim 11, further comprising:
a processor that is configured to communicate with the display, the processor being configured to process image data; and
a memory device that is configured to communicate with the processor.

14. The apparatus of claim 13, further comprising a driver circuit configured to send at least one signal to the display.

15. The apparatus of claim 14, further comprising a controller configured to send at least a portion of the image data to the driver circuit.

16. The apparatus of claim 13, further comprising an image source module configured to send the image data to the processor.

17. The apparatus of claim 16, wherein the image source module includes at least one of a receiver, transceiver, and transmitter.

18. The apparatus of claim 13, further comprising an input device configured to receive input data and to communicate the input data to the processor.

19. An illumination system comprising:
means for guiding light, the light guiding means having forward and rearward surfaces;
means for emitting light, the light emitting means configured to inject light into the light guiding means such that the injected light propagates through at least a portion of the light guiding means by total internal reflection at one or both of the forward and rearward surfaces;
spaced-apart regions of medium disposed over the forward or rearward surface, each spaced-apart region including means for diffracting light, the light diffracting means configured to redirect at least some of the light propagating through the light guiding means out of the light guiding means; and
a material disposed between adjacent spaced-apart regions, the material different from the medium.

20. The system of claim 19, wherein the light guiding means includes a light guide, or the light emitting means includes a light source, or the light diffracting means include holograms.

21. The system of claim 20, wherein the holograms include at least one of a reflection hologram and a transmission hologram.

22. The system of claim 19, wherein the material different from the medium has a refractive index less than a refractive index of the light guiding means.

23. A method of manufacturing an illuminating system, the method comprising:
providing a light guide having a forward surface and a rearward surface;
disposing spaced-apart regions of medium over the forward or rearward surface, each spaced-apart region including diffractive features configured to redirect at least some of the light propagating through the light guide out of the light guide; and
disposing a material between adjacent spaced-apart regions, the material different from the medium.

24. The method of claim 23, wherein disposing spaced-apart regions of medium further comprises:
forming a patterned layer over the forward or the rearward surface of the light guide, the patterned layer including a plurality of openings therein;
depositing a photopolymer into the plurality of openings;
removing the patterned layer to form a plurality of spaced-apart regions of the photopolymer; and
forming holographic features in the plurality of spaced-apart regions of the photopolymer.

25. The method of claim 23, wherein disposing spaced-apart regions of medium further comprises:
providing a sheet of a polymer material;
printing or embossing spaced-apart regions on the sheet, the spaced-apart regions including diffractive features on the sheet; and
laminating the sheet on the forward or rearward surface of the light guide.
